(19) United States
(12) Patent Application Publication
(10) Pub. No.: US 2014/0197282 A1
(43) Pub. Date: Jul. 17, 2014

(54) ADJUSTABLE HEIGHT PIPE SUPPORT

(71) Applicant: Thomas M. Turner, Twinsburg, OH (US)

(72) Inventor: Thomas M. Turner, Twinsburg, OH (US)

(21) Appl. No.: 13/739,464

(22) Filed: Jan. 11, 2013

(51) Int. Cl. F16L 3/12

(52) U.S. Cl. CPC F16L 3/12
USPC 248/49

(57) ABSTRACT

A pipe support for supporting pipes on a building surface comprising a strut vertically movable on supporting rods for changing the vertical spacing of a pipe above the building surface and spring clips connecting the strut to the rods, the spring clips having a locking position securing the strut in a fixed position and a release position that permits the strut to move along the rods.

### BACKGROUND OF THE INVENTION

The present invention relates generally to pipe supports, and, more specifically, to a new pipe support that can be quickly and easily adjusted to support a pipe at a selected height above a roof or other surface.

A widely used pipe support is disclosed in U.S. Pat. No. 6,682,025. It comprises a base and upstanding, flexible arms that receive and support a pipe at a fixed height above a roof. While this support is an improvement over prior methods of supporting pipe, the support cannot be adjusted to change the spacing of the pipe relative to the roof which is desirable in many installations.

U.S. Pat. No. 7,168,210 discloses a pipe support than can be adjusted to change the height position of the pipe above the roof. It comprises a base and upstanding threaded rods that carry a pipe supporting channel. The channel is secured to the rods by nuts and washers above and below each end of the channel. In order to change the height position of the supported pipe, it is necessary to adjust all of the nuts on the threaded rods.

### SUMMARY OF THE INVENTION

An object of the present invention is to provide new adjustable height pipe support which is an improvement over the prior art design that is characterized by the use of nuts that must be threaded up or down to place a supported pipe at a desired position above a roof. The invention resides in provision of quick release clips that, in one operative position, permit a pipe support strut to be moved to a selected position above a roof, and, in another operative position, secure the pipe support in its selected position.

As hereinafter disclosed, a pipe support strut is supported by upstanding rods. The quick release clips of the invention are secured on the strut for engaging the rods. In the disclosed embodiments, the clips have flexible legs through which the rods extend. The legs can be pressed to release a position allowing the strut to be adjusted along the length of rods. When the flexible legs are released, they spring to a position locking the strut to the rods.

### BRIEF DESCRIPTION OF THE DRAWINGS

FIG. 1 is a perspective view of an embodiment of the invention;

FIG. 2 is a top plan view of the support shown in FIG. 1;

FIG. 3 is a side elevational view of the support;

FIG. 4 is an end elevational view of the support;

FIG. 5 is a perspective view of an end block forming part of the support of FIG. 1;

FIG. 6 is a perspective of a spring clip forming part of the support of FIG. 1;

FIG. 7 is a perspective view of a second embodiment of the invention; and,

FIG. 8 is vertical cross-section of the embodiment of FIG. 7.

### DESCRIPTION OF PREFERRED EMBODIMENTS

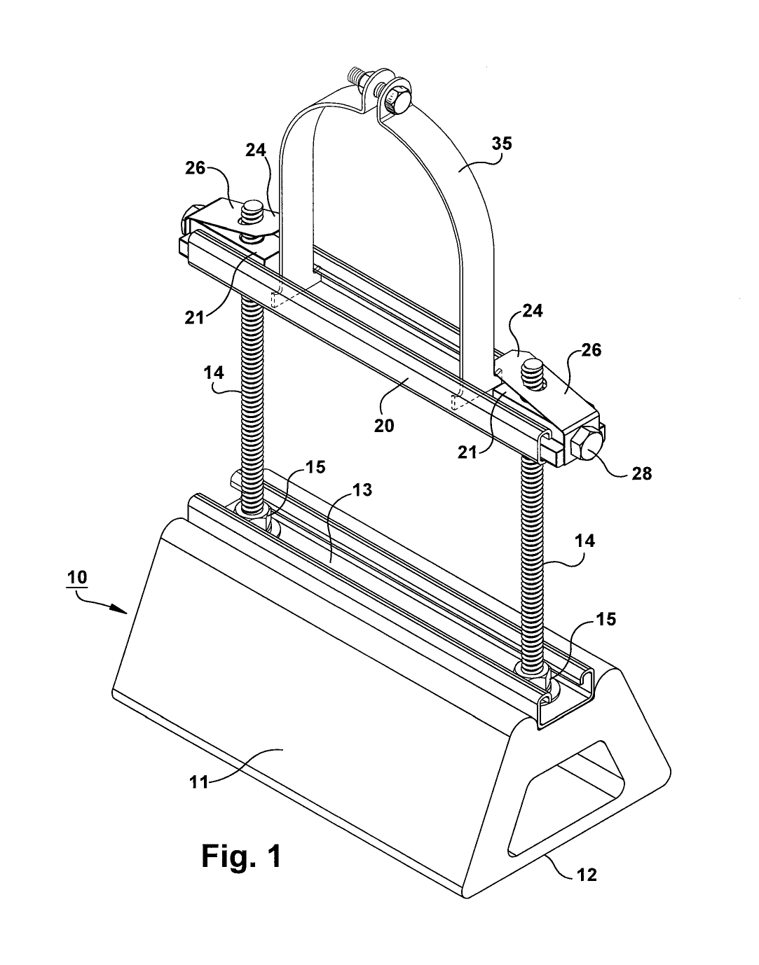

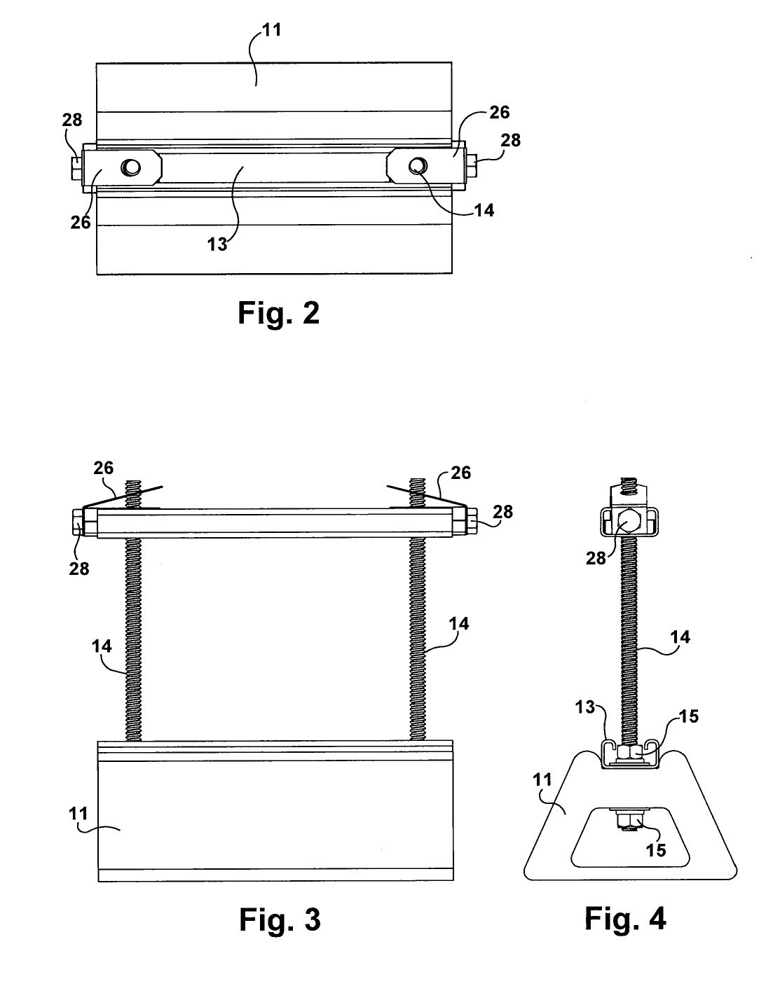

Referring now to the drawings, the embodiment of FIG. 1 is generally designated by reference number 10. The illustrated construction comprises base 11 having a flat surface 12 that rests on a building roof or other supporting surface, and a metal channel 13 secured in the top of the base. A pair of threaded rods 14 extend from the base 11 and are secured to the channel 13 by nuts 15.

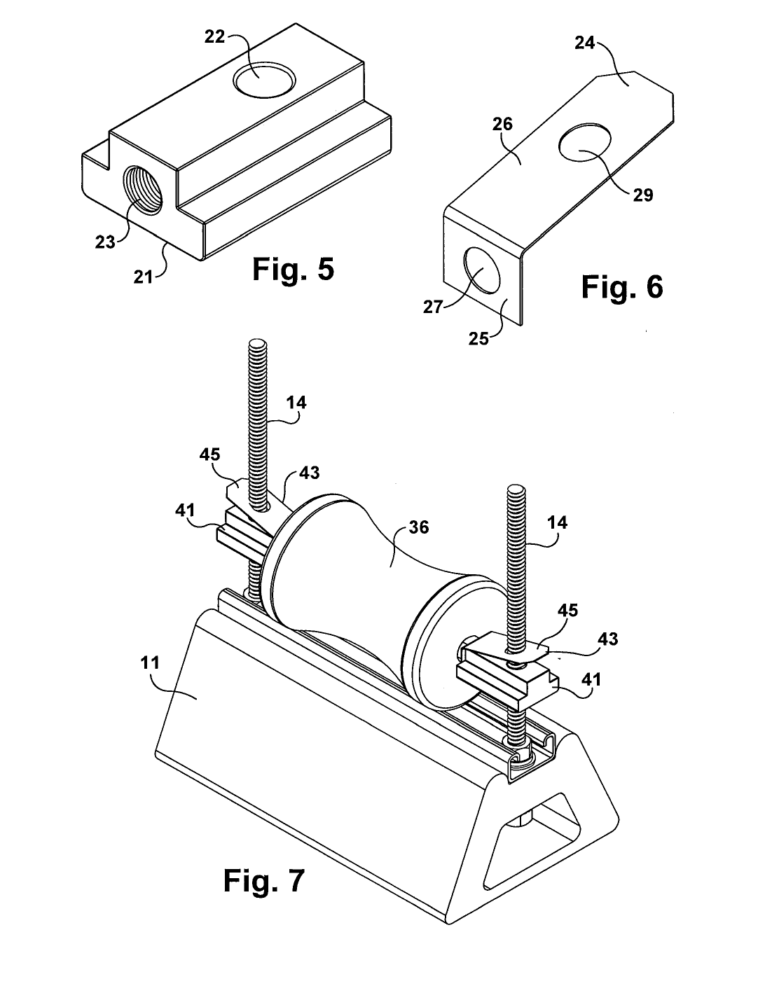

A moveable pipe support strut 20 is mounted of the rods 14. As shown, the strut is a channel member. T-shaped blocks 21 best shown in FIG. 5 are carried in the ends of the strut or channel member 20. The blocks have holes 22 through which the rods 14 extend and threaded end holes 23.

Spring clips 24 connect the strut 20 to the rods. As best shown in FIG. 6, each clip has a leg 25 and a flexible spring leg 26. The included angle formed by legs 25, 26, is greater the 90 degrees. The clip leg 25 has a hole 27 for permitting the leg to be connected to an end block 21 by a suitable fastener 28 threaded into the hole 23. The flexible spring leg 26 has a hole 28 that receives a rod 14. As shown, for example, in FIGS. 3 and 4, the legs 26 in their locking position are slanted with respect to the rods 14.

The diameters of the block holes 22 and the flexible clip leg holes 28 are sufficiently larger than the rod diameters so that the rods 14 can slide through the holes 22, 28 when the clip legs 26 are pressed toward the blocks 21. This permits the strut 20 to be slid to a desired position on the rods 14. When the clip legs 26 are released, they spring to the illustrated positions locking the strut 20 to the rods 13.

The rods 14 are shown and described as being threaded. The engagement of the clip legs 26 with the threads assure that the strut 20 will firmly lock the strut to the rods under all load conditions encountered in pipe support applications. Under some applications involving loads imposed by light weight pipe or tubing, the rods projecting above the channel 13 may be smooth or unthreaded. The slanted position of the clip legs 26 shown in the drawings will lock the strut to the smooth rods in these lighter load conditions.

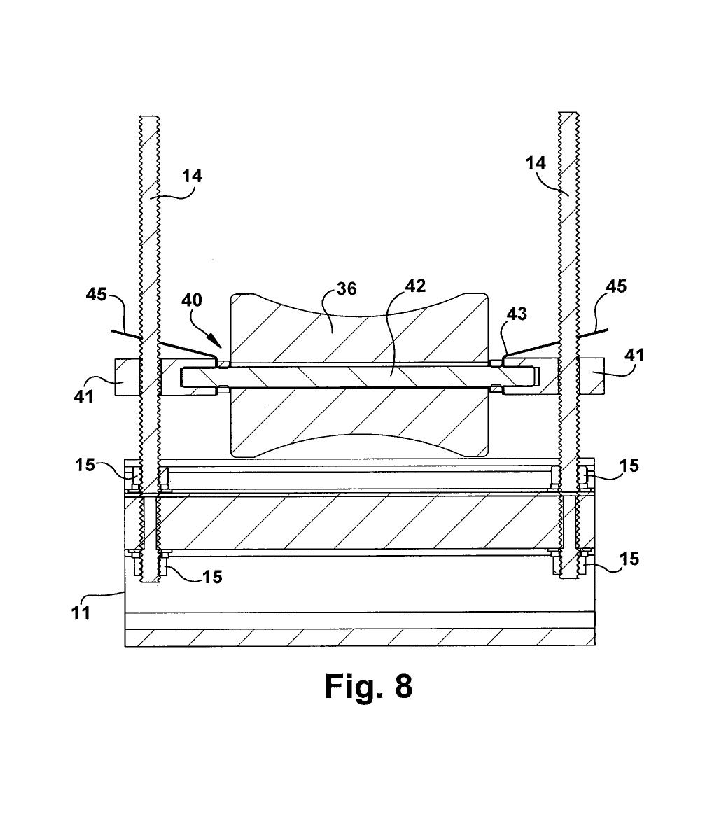

In FIG. 1, a conventional pipe clamp 35 is shown engaged in the channel shaped strut 20. In a second embodiment shown in FIGS. 7, 8, a pipe supporting roller 36 is carried by a strut 40 comprising end blocks 41 and a roller axle 42. In this embodiment, the end blocks 41 have enlarged holes for the rods 14 and engage the ends of the roller axle 42. Spring clips 43 have legs secured to the inner ends of the blocks 41 and 44. The flexible spring legs of the spring clips 45, like the previously described legs 26, have enlarged holes for the rods 14. As shown in FIGS. 7, 8 the legs 45 lock the strut 40 to the rods 14. When the leg is pressed toward the blocks 41, the roller supporting strut 40 can be easily moved to a desired height position.

In both embodiments of the invention, it will be appreciated that the spring clips can be quickly and activated between a locking position securing the pipe support strut to the upstanding rods and a release position permitting movement of the strut to a selected position on the rods. This is accomplished simply be processing then releasing the flexible legs of the clips.

Many modifications and variations of the disclosed invention, including but not limited to the use of smooth instead of threaded rods, will be apparent to those skilled in the art in light of the foregoing detailed disclosure. Therefore, it is to be understood that, within the scope of the following claims, the invention can be practiced otherwise than as specifically shown and described.

What is claimed:

1. An adjustable pipe support comprising:
a) a base having a bottom surface configured to rest on a building roof,
b) parallel rods extending from and secured to said base,
c) a pipe supporting strut mounted for movement on said rods to a selected height position above said base, and,
d) quick release clips carried on said strut, said clips having a locking position securing said strut to said rods and a release position permitting movement of said strut on said rods.

2. The pipe support as claimed in claim 1 wherein each clip comprises a first leg fixed to said strut and a second leg having a hole through which a rod extends, said legs forming an included angle greater than 90 degrees, and said second leg being flexible so that it is configured to be pressed from said locking position to said release position.

3. The pipe support as claimed in claim 2 wherein said rods are threaded.

4. The pipe support as claimed in claim 1 wherein said strut is a channel, and further comprising blocks in ends of the channel, said clips being fastened to said blocks, and said clips and blocks having holes through which said rods extend.

5. The pipe support as claimed in claim 4 wherein said clips have first legs fastened to said blocks and second legs, said legs forming an included angle greater than 90 degrees, and said second legs being flexible between said locking position engaging said rods and said release position permitting movement of said strut on said rods.

6. The pipe support as claimed in claim 5 wherein said rods are threaded.

7. The pipe support as claimed in claim 5 including a pipe clamp supported by said strut.

8. The pipe support as claimed in claim 5 including a pipe supporting roller carried by said strut.
